(19) United States
(12) Patent Application Publication
(10) Pub. No.: US 2005/0007222 A1
(43) Pub. Date: Jan. 13, 2005

(54) External auxiliary switching unit for circuit breaker

(76) Inventors: Takeshi Emura, Saitama (JP); Yoshinobu Hamada, Saitama (JP); Katsunori Kuboyama, Saitama (JP)

Correspondence Address: HAUPTMAN KANESAKA BERNER PATENT AGENTS, SUITE 300, 1700 DIAGONAL RD, ALEXANDRIA, VA, 22314-2848, US

(21) Appl. No.: 10/898,186

(22) Filed: Jul. 26, 2004

(30) Foreign Application Priority Data
Apr. 9, 2003 (JP) 2003-313032

(51) Int. Cl. H01H 73/00

(52) U.S. Cl. 335/132

(57) ABSTRACT

An external auxiliary switching unit includes a unit case, an auxiliary contact mechanism having contacts to be opened and closed in response to on/off operations of a circuit breaker, and an alarm contact mechanism operating in response to a tripping operation of the circuit breaker. An operating arm extends from a contact holder of the alarm contact mechanism and protrudes sideward from the unit case. The operating arm is inserted into a breaker housing when the auxiliary switching unit is mounted onto the circuit breaker. When the alarm output plate rotates upon tripping of the circuit breaker, the alarm output plate is released from the operating arm to detect the tripping and output an alarm signal. After the tripping, the circuit breaker is reset to cause the alarm contact mechanism to return to the non-detecting position via the alarm output plate, thereby stopping the alarm signal.

### BACKGROUND OF THE INVENTION AND RELATED ART STATEMENT

The present invention relates to an external auxiliary switching unit to be attached to a low-voltage circuit breaker such as an auto breaker for outputting an electric signal indicative of an ON/OFF state and a tripping state of the circuit breaker to an external device.

As an example of an external auxiliary switching unit (option) for a circuit breaker, there has been proposed an external auxiliary switching unit including an auxiliary contact mechanism for opening and closing contacts in response to on and off operations of the circuit breaker, and an alarm contact mechanism for closing contacts in response to a tripping operation of the circuit breaker (refer to Japanese Patent Publication (Kokai) No. 2001-160350).

Referring to FIGS. 6(a), 6(b), 7(a) and 7(b), a structure and operation of the external auxiliary switching unit disclosed in Japanese Patent Publication (Kokai) No. 2001-160350 will be explained. FIGS. 6(a) and 6(b) show a state in which the circuit breaker is off, and FIGS. 7(a) and 7(b) show a state in which the circuit breaker is tripped. In FIGS. 6(a), 6(b), 7(a) and 7(b), reference numeral 1 denotes an external auxiliary switching unit attached to a side surface of a housing of a circuit breaker 2, and reference numeral 3 denotes a unit case. The unit case 3 has an auxiliary contact mechanism 4 and an alarm contact mechanism 5 with structures described below. The auxiliary contact mechanism 4 is formed of fixed contacts 4a, bridging movable contacts 4b, and a contact holder 4d for holding the movable contacts 4b and a contact-pressure spring 4c. The contact holder 4d is supported to slide upwardly and downwardly within the unit case 3. The contact holder 4d is connected to an opening/closing shaft 2a provided in an opening/closing mechanism of the circuit breaker 2 via a driving lever 4e (when the circuit breaker 2 is turned on/off by operating a handle, the opening/closing shaft 2a turns counterclockwise/clockwise in response to the on/off operation of the circuit breaker 2).

With the construction, when the circuit breaker 2 is off, the contact holder 4d of the auxiliary contact mechanism 4 moves downwardly to an illustrated position to separate the movable contacts 4b from the fixed contacts 4a. In this state, when the circuit breaker 1 is turned on by operating the handle, the opening/closing shaft 2a turns counterclockwise from an illustrated position. In response to this movement, the contact holder 4d slides upwardly from the illustrated position so that the movable contacts 4b contact the fixed contacts 4a. Then, an electric signal indicative of the ON state of the circuit breaker 2 is output via the auxiliary contact mechanism 4.

The alarm contact mechanism 5 is disposed on an upper side of the auxiliary contact mechanism 4, and is formed of fixed contacts 5a, movable contacts (bridging type) 5b, a contact holder 5d for holding the movable contacts 5b and a contact spring 5c, and a driving spring (compression spring) 5e for urging the contact holder 5d downwardly. The contact holder 5d is juxtaposed to and disposed above the contact holder 4d of the auxiliary contact mechanism 4, and is supported to slide upwardly and downwardly. The contact holder 5d is provided with a latch plate 5f extending from an upper end of the contact holder 5d, and is connected to an alarm output plate 7 of the circuit breaker 2 via an alarm operation lever 6 facing an end of the contact holder 5d.

The alarm output plate 7 with an inverted V-shape has an upper end pivotally supported on the housing of the circuit breaker 2 via a pivot 7a; one leg piece (on the right side) connected to a latch of an opening/closing mechanism (not shown) via a pin 8; and the other leg piece having an end 7b extending toward the auxiliary switching unit 1. The other leg piece (on the left side) of the alarm output plate 7 functions as an actuator for an alarm switch (internal auxiliary device) incorporated in the circuit breaker 2. When an overload or short-circuit current flows through a main circuit and the circuit breaker 2 is tripped, the alarm output plate 7 rotates clockwise about the pivot 7a from a position shown in FIG. 6(b) toward a position shown in FIG. 7(b).

The alarm operation lever 6 is formed of a lever 6a, a pivot 6b, a return spring 6c for urging the lever 6a clockwise, and an alarm display section 6d. When the external auxiliary switching unit 1 is mounted on the circuit breaker 2, an end of the alarm operation lever 6 protrudes into the housing of the circuit breaker 2 via the window hole 2b formed in a side surface of the housing. At this position, the lever 6a faces the leg piece end 7b of the alarm output plate 7 such that the lever 6a crosses a moving path of the leg piece end 7b. Reference numeral 3a denotes an alarm display window formed in an upper surface of the unit case 3 and facing an upper end of the alarm display section 6d of the alarm operation lever 6.

With the construction of the alarm contact mechanism 5 described above, when the circuit breaker 2 is on or off, the lever 6a urged by the return spring 6c locks the latch plate 5f at a position shown in FIG. 6(b), so that the contact holder 5d is locked at an upward position and the movable contacts 5b are away from the fixed contacts 5a. In this state, when the circuit breaker 2 is tripped and the alarm output plate 7 rotates clockwise as shown in FIG. 7(b), the leg piece end 7b kicks an end of the alarm operation lever 6 while the alarm output plate 7 rotates.

Accordingly, the lever 6a rotates counterclockwise against the force of the return spring 6c, and is released from the latch plate 5f. When the lever 6a is released from the latch plate 5f, the contact holder 5d of the alarm contact mechanism 5 is pushed downwardly by the driving spring 5e and is placed upon the contact holder 4d of the auxiliary contact mechanism 4. As a result, the fixed contacts 5a and the movable contacts 5b are closed, and an electric signal indicating the tripping of the circuit breaker 2 is output. At the same time, the alarm display section 6d of the alarm operation lever 6 moves to a position under the alarm display window 3a to indicate that the circuit breaker 2 is tripped.

After the circuit breaker 2 is tripped, when the handle is moved to an OFF position to reset a circuit breaker tripping mechanism of the circuit breaker 2 and the handle is turned to an ON position to turn on the tripping mechanism, the contact holder 4d of the auxiliary contact mechanism 4 slides upwardly from the position shown in FIG. 7(a) via the opening/closing shaft 2a of the opening/closing mechanism and the driving lever 4e. Also, the contact holder 5d of the alarm contact mechanism 5 is pushed by the contact holder 4d to move upwardly, so that the movable contacts 5b are separated from the fixed contacts 5a. At the same time, the latch plate 5f moves upwardly and returns to the position shown in FIG. 6(b), and is locked again in this position.

In the alarm contact mechanism 5 installed in the external auxiliary switching unit, “a” type contacts are used in which the alarm contacts are turned on upon detection of tripping of the circuit breaker 2. Alternatively, “b” type contacts may be used as alarm contacts in which the alarm contacts are turned off upon the tripping and turned on otherwise.

In the conventional external auxiliary switching unit described above, as shown in FIGS. 6(a), 6(b), 7(a) and 7(b), when the contacts of the alarm contact mechanism 5 are closed in response to the tripping of the circuit breaker 2, and the alarm signal is output to an external device, the alarm contact mechanism 5 can not be turned off only by resetting the circuit breaker 2, and the alarm signal continues to be output. In order to stop the alarm signal, it is necessary to reset the circuit breaker 2 and then turn on the circuit breaker 2 again by operating the handle.

In such an operation method, however, the following problem remains in terms of management. Specifically, when the circuit breaker is tripped due to the overload or short-circuit current and the alarm signal is output, a person in charge of maintenance has to reset the tripped circuit breaker by switching the handle thereof to the OFF position. Also, it is necessary to check a distribution system to investigate a cause of the overload or short-circuit current, repair abnormal parts as needed, confirm the safety of the system, and then turn on the circuit breaker 2 to resume the power supply.

On the other hand, an alarming function for the external auxiliary switching unit for the circuit breaker is required to detect the tripping operation of the circuit breaker and output an alarm signal. When the alarm signal is continuously output even after the circuit breaker is reset, a person in charge of maintenance may misjudge the situation. For, this reason, once the tripped circuit breaker is reset, it is desirable to immediately stop the alarm signal output from the auxiliary switching unit without turning on the circuit breaker again.

In view of the problems described above, an object of the present invention is to provide an external auxiliary switching unit for a circuit breaker capable of detecting a tripping operation of the circuit breaker and outputting an alarm signal, and then stopping the alarm signal only when the circuit breaker is reset without turning on the circuit breaker again.

Further objects and advantages of the invention will be apparent from the following description of the invention.

### SUMMARY OF THE INVENTION

To attain the above objects, according to a first aspect of the present invention, an external auxiliary switching unit is attached to a circuit breaker for outputting an electric signal indicative of an on/off state and a tripped state of the circuit breaker. The external auxiliary switching unit includes a unit case, an auxiliary contact mechanism disposed in the unit case and having contacts to be opened and closed in response to on/off operation of the circuit breaker, and an alarm contact mechanism disposed in the unit case and operating in response to a tripping operation of the circuit breaker. The auxiliary contact mechanism is connected to an opening/closing shaft of the circuit breaker, and the alarm contact mechanism is connected to a rotating alarm output plate of the circuit breaker operating in response to the tripping operation of the circuit breaker. An operating arm extends from a contact holder of the alarm contact mechanism and protrudes sideward from the unit case. The operating arm is inserted into a breaker housing in a state that the auxiliary switching unit is mounted onto the circuit breaker.

When the circuit breaker is on or off, the operating arm is supported on the alarm output plate to hold the alarm contact mechanism at a non-detecting position. When the alarm output plate rotates upon tripping of the circuit breaker, the alarm output plate is released from the operating arm to detect the tripping and output an alarm signal. After the tripping, the circuit breaker is reset to cause the alarm contact mechanism to return to the non-detecting position via the alarm output plate, thereby stopping the alarm signal.

According to a second aspect of the present invention, a tapered guide surface is formed at an end of a leg piece of the alarm output plate provided in the circuit breaker, so that the alarm contact mechanism is properly set at the non-detecting position when the external auxiliary switching unit is mounted onto the circuit breaker. When the external auxiliary switching unit is mounted onto the circuit breaker, the operating arm of the alarm contact mechanism is arranged along the tapered guide surface to be supported on the alarm output plate.

With the above construction, from the state in which the tripping operation of the circuit breaker is detected and the alarm signal is output from the external auxiliary switching unit, when a handle of the circuit breaker is moved to an OFF position to reset the circuit breaker, the alarm contact mechanism returns to the non-detecting position in response to the above movement, thereby immediately stopping the alarm signal. Accordingly, as compared with the conventional auxiliary switching unit, the alarm signal is not continuously output before the tripped circuit breaker is turned on again. Also, in terms of structure, it is not necessary to provide a part of the alarm operation lever connected to the alarm contact mechanism, thereby reducing the number of parts, man-hour for assembly, and production cost.

Further, in the second aspect of the present invention, it is easy to mount the external auxiliary switching unit onto the circuit breaker.

### BRIEF DESCRIPTION OF THE DRAWINGS

FIGS. 1(a) and 1(b) are views for explaining an operation of an alarm contact mechanism in an external auxiliary switching unit according to an embodiment of the present invention, wherein FIG. 1(a) shows an operative state of the alarm contact mechanism when a circuit breaker is on/off, and FIG. 1(b) shows an operative state of the alarm contact mechanism when the circuit breaker is tripped;

FIG. 2 is a view showing an operative state of an internal contact mechanism of the external auxiliary switching unit when the circuit breaker is on;

FIG. 3 is a view showing an operative state of the internal contact mechanism of the external auxiliary switching unit when the circuit breaker is off;

FIG. 4 is a view showing an operative state of the internal contact mechanism of the external auxiliary switching unit when the circuit breaker is tripped;

FIG. 5 is a view for explaining a process of mounting the external auxiliary switching unit on the circuit breaker;

FIGS. 6(a) and 6(b) are views for explaining a structure and operation of a conventional external auxiliary switching unit, wherein FIG. 6(a) shows an operative state of an internal contact mechanism when a circuit breaker is on, and FIG. 6(b) is a side sectional view showing a connecting structure between an alarm operation lever and an alarm output plate of the circuit breaker shown in FIG. 6(a); and

FIGS. 7(a) and 7(b) are views for explaining an operation of the conventional external auxiliary switching unit when the circuit breaker is tripped, wherein FIG. 7(a) shows an operative state of the internal contact mechanism, and FIG. 7(b) shows an operative state of the alarm operation lever.

### DETAILED DESCRIPTION OF PREFERRED EMBODIMENTS

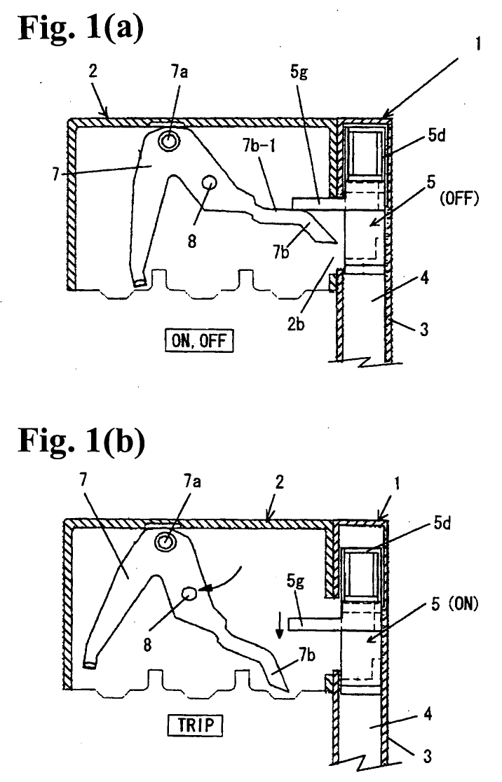

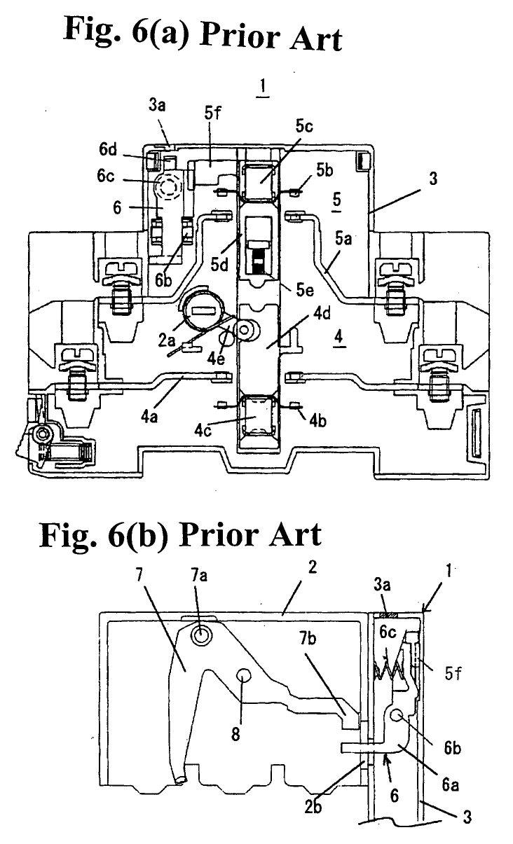

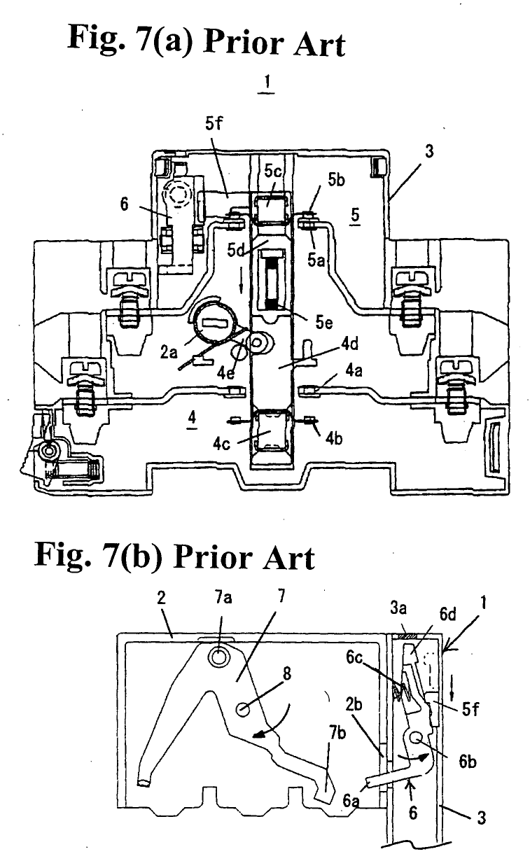

Hereunder, embodiments of the present invention will be described with reference to FIGS. 1(a) to 5. In FIGS. 1(a) to 5, members corresponding to those shown in FIGS. 6(a), 6(b), 7(a) and 7(b) are denoted by the same reference numerals, and description thereof is omitted. An external auxiliary switching unit 1 according to the present embodiment shown in FIGS. 1(a) to 5 has a structure basically identical to that of the conventional one shown in FIGS. 6(a), 6(b), 7(a) and 7(b), except a connecting structure between an alarm contact mechanism 5 and an alarm output plate 7 provided in a housing of a circuit breaker 2.

An alarm operation lever 6 (refer to FIGS. 6(a), 6(b), 7(a) and 7(b)) is omitted from the alarm contact mechanism 5 provided in the external auxiliary switching unit 1. An operating arm 5g is formed integrally with the contact holder 5d in place of the alarm operation lever 6. The operating arm 5g extends sideward from a unit case 3. The alarm output plate 7 disposed in the housing of the circuit breaker 2 is provided with a flat shoulder part 7b-1 formed at an upper edge of an end 7b of a leg piece (on the right side in the drawing) and extending toward the auxiliary switching unit 1 for supporting the operating arm 5g from below.

A tapered guide surface 7b-2 (refer to FIG. 5) is inclined downwardly from a shoulder 7b-1 toward an end. When the circuit breaker 2 is on or off, the tapered guide surface 7b-2 formed at the end of the alarm output plate 7 faces the center of a window hole 2b formed in a side surface of the housing of the circuit breaker 2 as shown in FIGS. 1(a) and 5. Other than the portions described above, the auxiliary switching unit according to the present embodiment has an internal structure identical to the conventional one shown in FIGS. 6(a), 6(b), 7(a) and 7(b). The auxiliary contact mechanism 4 connected to an opening/closing shaft 2a of the circuit breaker 2 is disposed on a lower side of the alarm contact mechanism 5. It should be noted that an operating arm 5g of the contact holder 5d may be formed with a tapered guide surface.

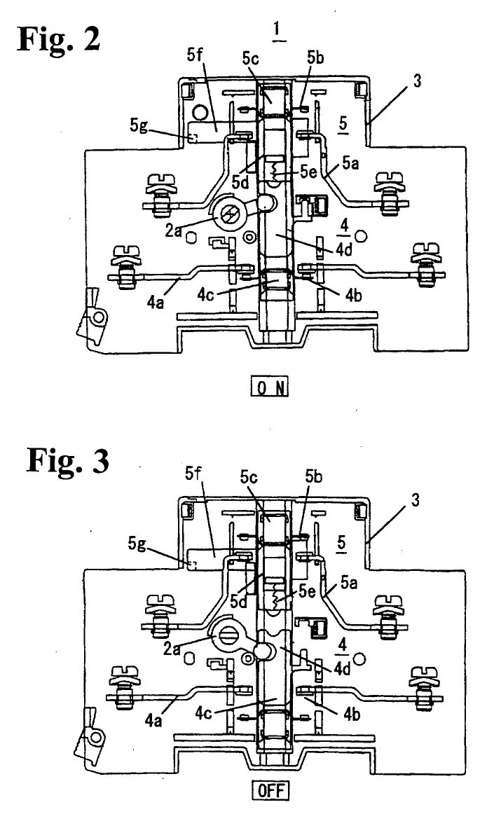

In the above construction, the circuit breaker 2 is mounted onto the external auxiliary switching unit 1. At this time, when the unit case 3 is placed upon a sidewall of the housing of the circuit breaker 2 from a side as shown in FIG. 5, an end of the operating arm 5g protruding from the unit case 3 abuts against a tapered guide surface 7b-2 of the alarm output plate 7 provided in the circuit breaker 2 (where the alarm output plate 7 is held), and then is pushed upwardly along the inclined surface to be supported on the shoulder part 7b-1. In this state, the contact holder 5d formed integrally with the operating arm 5g moves upwardly, so that movable contacts 5b of the alarm contact mechanism 5 are held at OFF positions (non-detection position of a tripping operation) away from fixed contacts 5a (refer to FIGS. 2 and 3).

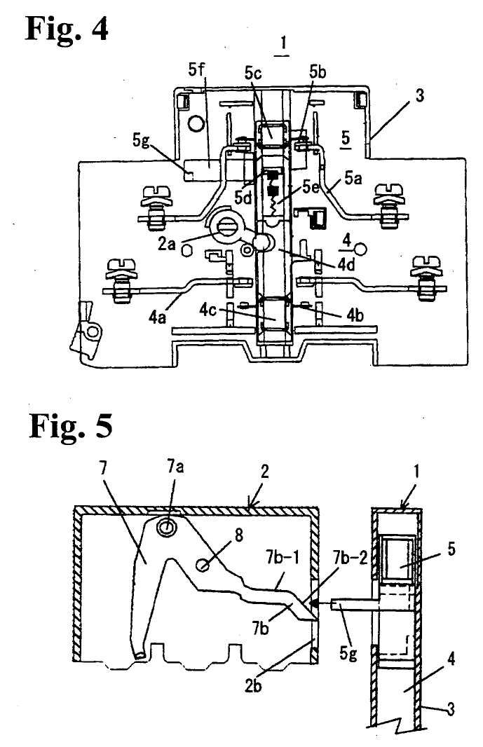

When the circuit breaker 2 is tripped due to an overload or short-circuit current through the distribution system, the alarm output plate 7 rotates to a position shown in FIG. 1(b) in response to the tripping operation, and releases the operating arm 5g pushed up and held by the alarm output plate 7. As a result, the contact holder 5d of the alarm contact mechanism 5 moves downwardly due to the force of the driving spring 5e. Then, as shown in FIG. 4, the movable contacts 5b and the fixed contacts 5a are closed, and an alarm signal is output from the alarm contact mechanism 5.

On the other hand, when a person in charge of maintenance has confirmed the alarm signal and rotates a handle of the circuit breaker 2 to an OFF position to reset the circuit breaker 2, the alarm output plate 7 rotates and returns from a position shown in FIG. 1(b) to a position shown in FIG. 1(a). During the rotation of the handle, the alarm output plate 7 pushes up the operating arm 5g to protrude into a movement path of the leg piece. As a result, the alarm contact mechanism 5 of the external auxiliary switching unit 1 returns to an opened state shown in FIG. 3, thereby stopping the alarm signal. Thereafter, when the distribution system is confirmed to be safe and the circuit breaker 2 is turned on again, the alarm contact mechanism 5 stopped-outputting the alarm signal is maintained in the present state, and the auxiliary contact mechanism 4 becomes a state shown in FIG. 2 to output an ON signal.

In the present embodiment, the alarm contact mechanism 5 has the contacts ‘a’ to be closed upon the detection of the tripping operation of the circuit breaker. Alternatively, the alarm contact mechanism 5 may have contacts ‘b’ to be opened upon the detection of the tripping operation.

The disclosure of Japanese Patent Application No. 2003-313032 filed on Sep. 4, 2003 has been incorporated in the application.

While the invention has been explained with reference to the specific embodiments of the invention, the explanation is illustrative and the invention is limited only by the appended claims.

1. An external auxiliary switching unit to be attached to a circuit breaker for outputting electric signals indicative of an on/off state and a tripped state of the circuit breaker, comprising:
a unit case,
an auxiliary contact mechanism disposed in the unit case and having contacts to be opened and closed in response to on/off operations of the circuit breaker, said auxiliary contact mechanism being connected to an opening/closing shaft of the circuit breaker,
an alarm contact mechanism disposed in the unit case and having a contact holder for operating in response to a tripping operation of the circuit breaker, said alarm contact mechanism being connected to a rotating alarm output plate of the circuit breaker, and
an operating arm extending from the contact holder of the alarm contact mechanism and protruding sideward from the unit case, said operating arm being located in a breaker housing when the auxiliary switching unit is mounted onto the circuit breaker and being supported on the alarm output plate to hold the alarm contact mechanism at a non-detecting position when the circuit breaker is on or off, said operating arm releasing the alarm output plate to detect the tripping operation and output the electrical signal when the alarm output plate rotates upon the tripping operation of the circuit breaker so that when the circuit breaker is reset after the tripping operation, the alarm contact mechanism returns to the non-detecting position via the alarm output plate to stop the electrical signal.

2. An external auxiliary switching unit according to claim 1, wherein said operating arm is arranged to move along a tapered guide surface formed at an end of a leg piece of the alarm output plate provided in the circuit breaker to be supported on the alarm output plate when the external auxiliary switching unit is mounted onto the circuit breaker.

3. An external auxiliary switching unit according to claim 1, wherein said operating arm is arranged to slide along the contact holder.

4. An external auxiliary switching unit according to claim 3, further comprising urging means attached to the operating arm to move the operating arm in a detecting position.
